(19) United States
(12) Patent Application Publication
(10) Pub. No.: US 2003/0056005 A1
(43) Pub. Date: Mar. 20, 2003

(54) Method of forming and managing itineraries, and a network implementing such a method

(75) Inventors: Veronique Daurensan, Antony (FR); Olivier Poupel, Bretigny Sur Orge (FR)

Correspondence Address: SUGHRUE, MION, PPLC, 2100 Pennsylvania Avenue, N.W., Washington, DC, 20037-3213, US

(73) Assignee: ALCATEL

(21) Appl. No.: 10/188,086

(22) Filed: Jul. 3, 2002

(30) Foreign Application Priority Data
Jul. 5, 2001 (FR) 01 08 938

(51) Int. Cl. G06F 15/173; G06F 17/60

(52) U.S. Cl. 709/238; 705/7

(57) ABSTRACT

The present invention relates to a method of forming and managing itineraries or routes and to a network implementing the method. The method of forming and managing itineraries or routes consists in providing a plurality of software modules each controlling and verifying one or more means and/or resources, and having means for communicating with one or more other modules to form an itinerary by building up an ordered chain or succession of software modules allocated to said itinerary and each locked in a given state that depends on its contribution to said itinerary, and in dismantling said itinerary after it has been used by releasing said software modules allocated thereto, the various stages of existence of such an itinerary being defined by consecutive operating sequences affecting said software modules and their associated means and/or resources, and comprising successive allocation, control/verification, and release sequences.

The present invention relates to the fields of transportation and of transmission and it relates in particular to a method of forming and managing itineraries, and to a network implementing the method.

### BACKGROUND OF THE INVENTION

Both in the field of transportation and in the field of transmission, there are to be found structures in which means and/or resources need to co-operate mutually and in a determined order for the purpose of temporarily constituting a transport or transmission path suitable for enabling the desired routing to be implemented.

In complex structures of large size, one of the crucial problems is the safety and reliability of routing, given the multiplicity of the possible configurations and simultaneous uses that can be made of the means and resources of said structure by different users and for different tasks.

At present, there exists a clear need for functional safety that is optimized in terms of sureness and simplicity of implementation.

Solutions already exist for making routings safe in such transportation and transmission structures, however they are relatively complex, cumbersome to test and to implement, and they require considerable expenditure in order to guarantee good reliability and good safety.

### OBJECTS AND SUMMARY OF THE INVENTION

A particular object of the present invention is to mitigate those above-specified drawbacks and to provide a solution that is integrated and generic, enabling a high level of safety and of reliability to be guaranteed.

To this end, the present invention provides a method of forming and managing itineraries or routes formed from appropriate means and implementing suitable resources, in particular track circuits, signaling circuits, and junction points, the method consisting in providing a plurality of software modules each controlling and verifying one or more means and/or resources of the above-specified type, and comprising means for communicating with one or more other modules in order to respond to a request from an operator transmitted by means of an operating module capable of communicating with all of said modules to form an itinerary by building up an ordered chain or succession of software modules allocated to said itinerary and each locked in a given state that is a function of its contribution to said itinerary, and to dismantle said itinerary after it has been used by releasing said software modules allocated thereto, the various stages in the existence of such an itinerary being defined by consecutive operating sequences affecting said software modules and their associated means and/or resources, and comprising successive sequences for allocation, control/verification, and release.

According to a first characteristic of the invention, the above-specified method consists in defining the beginning of an itinerary by an entry signal associated with an entry module, and the end of an itinerary by an exit signal associated with an exit module, the instruction messages generated by the entry module being transmitted, in the absence of any conflict or fault, along the chain of modules corresponding to the itinerary that has been formed, each inbetween module of said chain being aware of and capable of communicating with at least the module upstream therefrom and the module downstream therefrom in said chain, and the exit module being suitable for forwarding to the entry module the messages that have been received and processed successfully by the modules of said chain, with only one message at a time propagating along the itinerary.

In association with the sequences or stages in which an itinerary exists, functional safety is advantageously defined by the facts that after a given itinerary has been formed, the means and resources allocated to said itinerary in a state that has been verified as being correct are made unavailable for any other itinerary, that the entry signal remains allocated to a given itinerary throughout the entire duration of use and existence of said itinerary, and that the release sequence is applied initially to the entry signal.

The stage of allocating modules to an itinerary is implemented by causing an allocation request message to propagate from module to module towards successive downstream modules starting from the entry module and going towards the exit module, the exit module returning said message to the entry module in the event of the corresponding itinerary being successfully opened, with the modules being allocated exclusively to the chain formed in this way.

The verification stage consists in causing a verification request message to propagate to successive downstream modules, each module verifying the state of the associated means or resources as a function of the itinerary in question, in particular to detect state errors or breakdowns, in forwarding said message from the exit module to the entry module in the event of all of the inbetween modules and the exit module being verified successfully, and finally in verifying said entry module, thereby terminating said verification sequence.

The release stage consists in propagating a release command successively from module to module along the chain of modules corresponding to the itinerary in question, the release command being forwarded from a module to the following module automatically or after verifying a corresponding state of the means or resources attached to the upstream module in question, with this being done as a function of the nature of the module in question and the means or resources attached thereto.

In order to facilitate itinerary management, the operating module is systematically and automatically informed of the interruption or the successful completion of a given operating sequence, an interruption of an allocation sequence or of a control/verification sequence leading automatically to the itinerary in question being released.

The present invention also provides a transmission or travel network comprising a plurality of means and resources suitable for co-operating to form routing itineraries, in particular track circuits and junction points, and an interlock system for forming and managing routes or itineraries in said network, wherein said system comprises firstly a plurality of software modules each controlling and inspecting a plurality of means and/or resources and having means for communicating with one or other modules, said modules being capable of being temporarily assembled together in ordered chains to form determined itineraries in accordance with instructions from an operator, and secondly an operating module forming an interface between the software modules of said system and the operator, and managing the itineraries formed in said network, in particular setting them up by allocating corresponding software modules and dismantling them by releasing said modules, the various stages in the existence of such an itinerary being defined by consecutive operating sequences affecting said software modules and their associated means and/or resources and comprising successive sequences for allocation, control/verification, and release.

Each itinerary is made up of an entry module suitable for generating an entry signal, one or more inbetween modules, and an exit module suitable for generating an exit signal, the instruction messages issued by the entry signal from the entry module being forwarded in the absence of conflict or fault, along the chain of modules corresponding to the itinerary being formed, each inbetween module of said chain being aware of and capable of communicating with at least the module upstream therefrom in said chain and with the module downstream therefrom in said chain, and the exit module being suitable for forwarding to the entry module those messages that have been received and processed successfully by the modules of said chain, only one message at a time propagating along the itinerary.

Advantageously, the above-specified network is suitable for implementing the above-described method.

Naturally, the messages passing along the itinerary, and in particular over a portion only thereof, are not all messages coming from the entry module. Messages can also be transmitted from a inbetween module to another inbetween module of the itinerary without starting from the entry module and/or without reaching the exit module.

### BRIEF DESCRIPTION OF THE DRAWINGS

The invention will be better understood from the following description which relates to a preferred embodiment, given by way of non-limiting example, and explained with reference to the accompanying diagrammatic drawings, in which:

FIG. 1 is a diagram of a network having two sets of means and resources represented symbolically by their associated software modules;

FIG. 2A is an operational summary diagram showing the propagation of the allocation request message through a chain of software modules corresponding to a given itinerary, for a successful allocation;

FIG. 2B is an operational summary diagram showing the propagation of messages through the FIG. 2A chain for an unsuccessful allocation;

FIG. 3 is a detail diagram showing the operations of controlling and verifying a means or a resource (in the form of a junction point) by a software module;

FIG. 4A is an operational summary diagram showing the propagation of a verification request message through the chain of FIG. 2A in the event of a successful verification sequence;

FIG. 4B is an operational summary diagram showing the propagation of messages through the FIG. 2A chain in the event of unsuccessful verification;

FIG. 5A is an operational summary diagram showing the messages transmitted between the modules associated with the track circuits and the entry module during a stage prior to release; and

FIG. 5B is an operational summary diagram showing the transmission of the release message through the chain of FIG. 3, while the release sequence is taking place.

### MORE DETAILED DESCRIPTION

The method of the invention as described above can be applied to various types of network, such as in particular networks for transportation by railway tracks or networks for communications or for telecommunications.

The interlock system forming part of such a network and implementing the method of the invention can be dimensioned as a function of the network. Its architecture relies on a set of components communicating with one another, which components can be distributed over a plurality of computers, the system of distributed components complying with the implementation of the basic rules which ensure functional safety.

The invention makes it possible to achieve integrated processing resulting in implementing generic rules which ensure functional safety of such an interlock system, and the solution proposed corresponds to operational and functional sequences for each step in the lifetime of an itinerary 1: allocation, verification and controlling, release.

The concept of itinerary lifetime as mentioned above makes it possible to comply with three basic rules for ensuring functional safety of an interlock system forming part of a network of the invention.

The three basic rules for ensuring functional safety can be developed as follows:

1. Once an itinerary has been established, all of the resources belonging to it:

are allocated to it;

have been verified as being correct; and

the junction points have been locked so that they cannot be moved.

At this point the resources can neither be allocated nor verified for another itinerary.

2. Once a train penetrates into an itinerary:

the entry signal is put into its most restrictive state (red) ; and

the entry signal remains allocated until the train has fully entered the itinerary.

3. Once an itinerary has been released:

the first resource to be released is the entry signal; and

all of the other resources are released after the itinerary release sequence.

These three above-specified rules make it possible to provide complete functional safety and, when applied to a railway network, make it possible to guarantee that the following are avoided:

head-on collisions;

head-to-tail collisions;

trains derailing on passing over junction points; and

head-to-side collisions.

In order to satisfy the three main rules described above, three stages in the existence of an itinerary are defined in accordance with the invention.

Firstly, the operator (by means of the operating module) requests that an itinerary be set up.

The setting up of an itinerary implies:

the stage of allocating the itinerary;

the stage of controlling and verifying the itinerary; and

the stage of releasing the itinerary which begins when the train comes onto the itinerary (in the specific application mentioned above).

With reference to the accompanying figures, there follows a description of an application of the invention in the context of a railway network, it being recalled that the invention is not limited to such an application.

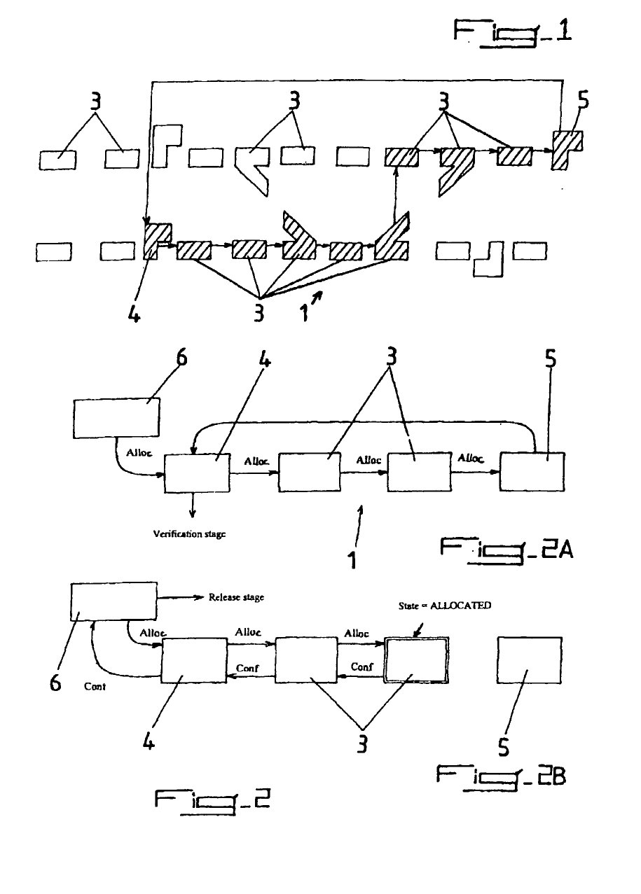

As shown in FIG. 1 of the accompanying figures, an itinerary 1 is an ordered succession of software modules 3, 4, 5 (also referred to as automatons) which control and verify on-site elements (signals, track circuits, junction points), referred to above as means or resources 2.

Given the way an itinerary is defined in the invention, each software module 3, 4, 5 is allocated once and once only for an itinerary 1 between the instant the itinerary is set up until the instant at which said itinerary is released. Each module 3, 4, 5 knows which modules are adjacent thereto (after it and before it) for each itinerary 1.

In FIG. 1, the modules 3, 4, 5 allocated to the itinerary 1 are shaded (ten modules are shaded in the example shown), the modules that are not shaded lying off said itinerary. Each module 3, 4, 5 knows its states associated with an itinerary 1 for the allocation and controlling stages.

The elements associated with the modules 3 shown in the accompanying figures are mainly of two types: track elements and switch or junction points.

The modules 3 associated with track elements are represented in the form of rectangular blocks in FIG. 1, and the modules 3 associated with switch or junction points are represented in the form of forked blocks in FIG. 1.

An element that is in a locked state cannot modify its state while it is locked. However it can be allocated to any itinerary, even while locked. The condition is that the itinerary must be capable of being set up with said element in such a state.

The beginning of an itinerary 1 is always defined by an entry signal, associated with a module or automaton 4, and the end of an itinerary is always defined by an exit signal associated with a module 5. The entry signal is the master for the stage of allocating the itinerary, the stage of controlling the itinerary, and the stage of releasing the itinerary.

The messages generated by the entry signal are transmitted along the chain defined by the set of modules 3, 4, 5 associated with the itinerary 1. The last module, defined as being the exit module 5, returns to the entry module 4 all the messages it has received and processed.

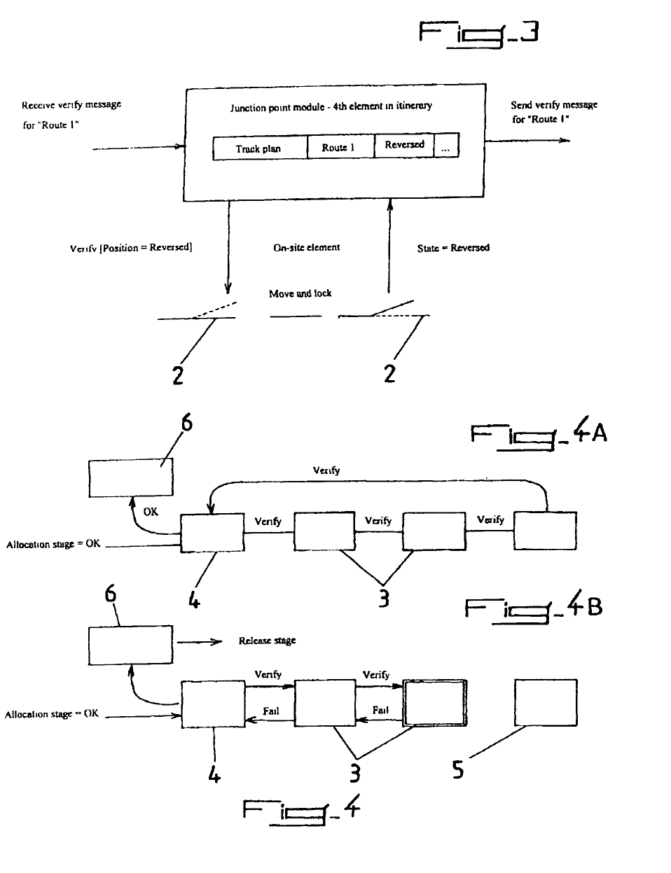

Allocating an Itinerary (FIGS. 2A and 2B)

An itinerary is allocated by allocating the software modules 3, 4, 5, which constitute the itinerary 1.

When the entry module 4 receives an “allocation” request coming from the operating module 6, it enters into the allocation stage. From this moment onwards, it is allocated to the current itinerary (unless it has already been allocated). The module 4 sends an “allocation” request to the following module 3 situated downstream, which in turn forwards it to the module 3 or 5 situated downstream, and so on until the module 5 is reached, thereby causing the request to propagate along the itinerary. When a software module 3, 5 receives such a message, it begins by verifying that it has not already been allocated.

Under such conditions, two circumstances can arise:

a) The software module 3, 5 of itinerary 1 has already been allocated for another itinerary or is not in the correct allocation state, in which case this module halts propagation of the allocation message and returns a conflict message “Conf” to the upstream module. Each of the successive upstream modules in the itinerary that is being formed then deallocates itself back to the module 4 of the entry signal, which sends a message to the operating module 6 informing it of this non-allocation. Thereafter, this itinerary cannot be opened (FIG. 2B). Automatic release of the itinerary can then be launched.

b) The software module is not allocated, so it is in a “NOT ALLOCATED” state. Under such circumstances, it allocates itself by causing its state to switch to “ALLOCATED” and sends the allocation message to the following software module of the itinerary. In the last software module (the exit signal module 5), the message is returned to the entry module 4. This means that all of the modules of the itinerary are allocated in a manner that is exclusive to said itinerary and therefore that no conflict exists. The entry signal module 4 then enters into the verification stage (FIG. 2A).

Verification of the Itinerary

This verification stage is started after an allocation stage has been performed correctly.

When the entry module 4 receives the returned allocation message coming from the exit signal module 5, it enters into the verification stage. It sends a “verification” request to the following module 3 situated downstream, which in turn forwards it to the following module 3 or 5 downstream, and so on to the module 5, so that the request is propagated along the itinerary 1.

When a software module receives this message, it verifies that its associated on-site element 2 is in the correct position. Each software module knows its own state for every possible requested itinerary. It is responsible for detecting state errors or breakdowns in on-site equipment.

The following two circumstances can arise:

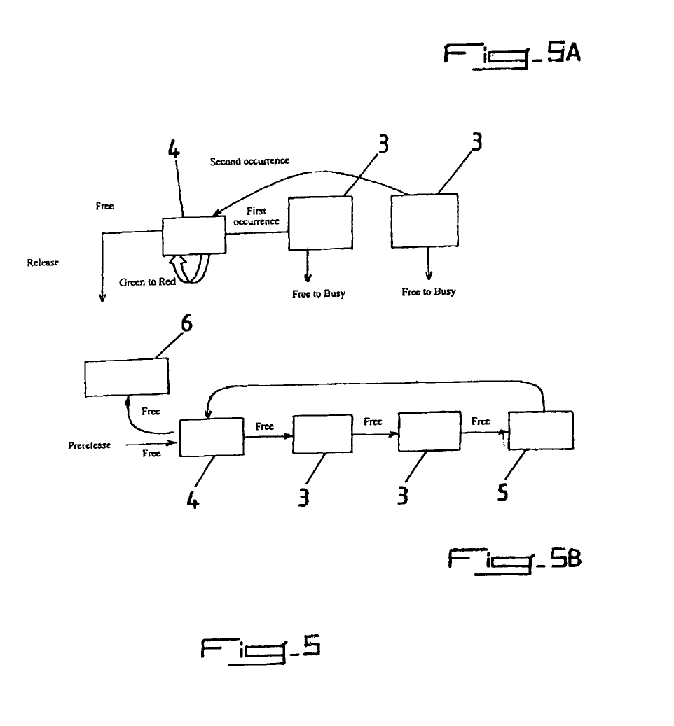

a) The control of a software module breaks down because of a breakdown in an associated piece of equipment 2 or because of a state error. The module then halts propagation of the control message and returns a “verification failed” message back towards the upstream module, which message is propagated along the itinerary in the upstream direction to the entry signal module 4 which delivers a “failure acknowledgment” to the operating module 6 (FIG. 4B). Automatic release of the itinerary can then be launched.

b) The controlling of a software module is correct (refer to FIG. 3). In which case this module continues the propagation of the control message and sends a “verification” message towards the downstream module, said message being propagated from module to module along the itinerary. When the on-site element 2 is in the form of a junction point, in addition to controlling the junction points to take up the correct position (normal or inverse position), the junction point motor is locked so as to prevent the junction point from moving: the state is locked so as to be incapable of moving. In the last software module (the exit signal module 5), the message is returned towards the entry module 4. The entry module 4 is the last module to be verified. If this last verification is also correct, that means that all of the modules 3, 4, 5 of the itinerary 1 are in the correct state for said itinerary 1, and that no breakdown or fault exists (FIG. 4A). The entry signal module 4 can thus be opened (switched to green or to some other authorization state) to allow the train to enter the itinerary 1 that has been verified successfully. The operator's operating module 6 is informed.

Release of the Itinerary

The entry signal module 4 is closed as soon as the first tract circuit device 2 detects the train. The entry signal module controls a red signal (STOP). The entry module and signal are released as soon as the second track circuit 2 corresponding to the second module 3 detects the train. The signal generates the release command, and sends it to the first module 3 of the track circuit 2. This track circuit 2 waits for a changeover from an “occupied” state to an “unoccupied” state and then uses its associated module 3 to forward the release command to the following software module 3. Each module is released by the train and forwards the release command to the following module, once its own release condition has been satisfied. When the message returns to the entry module 4, the entry module sends a message to the operating module 6 to indicate that release of the itinerary has been completed (FIG. 5B).

a) Automatic Release of a Track Circuit

When a track circuit 2 receives a release command, its associated module 3 is automatically released as soon as its release condition is satisfied. In general, the release condition of a track circuit is switched from an “occupied” state to a “unoccupied” state, except for the last track circuit. The last track circuit ahead of the exit signal is released as soon as it detects a train and it has received the release command (FIG. 5A).

b) Automatic Release of a Junction Point or of a Signal

No release condition is associated with means in the form of a junction point or with a resource in the form of a signal. Consequently, the corresponding module 3 is released as soon as it receives the release command and has forwarded said message to the following module.

The invention thus makes it possible to provide a method of forming and managing itineraries, and also an interlock system, enabling a high degree of functional safety to be provided in simple manner in the context of operating a network that may comprise a very large number of pieces of equipment, while avoiding any risk of collision, in particular.

Naturally, the invention is not limited to the embodiment described and shown in the accompanying drawings. Modifications are possible, particularly concerning the structure of the various elements or by substituting technical equivalence, without that going beyond the field of protection of the invention.

1/ A method of forming and managing itineraries or routes formed from appropriate means and implementing suitable resources, in particular track circuits, signaling circuits, and junction points, the method consisting:
in providing a plurality of software modules each controlling and verifying one or more means and/or resources of the above-specified type, and comprising means for communicating with one or more other modules in order to respond to a request from an operator transmitted by means of an operating module capable of communicating with all of said modules to form an itinerary by building up an ordered chain or succession of software modules allocated to said itinerary and each locked in a given state that is a function of its contribution to said itinerary, and to dismantle said itinerary after it has been used by releasing said software modules allocated thereto, the various stages in the existence of such an itinerary being defined by consecutive operating sequences affecting said software modules and their associated means and/or resources, and comprising successive sequences for allocation, control/verification, and release; and
in defining the beginning of an itinerary by an entry signal associated with an entry module, and the end of an itinerary by an exit signal associated with an exit module, the instruction messages generated by the entry module being transmitted, in the absence of any conflict or fault, along the chain of modules corresponding to the itinerary that has been formed, each inbetween module of said chain being aware of and capable of communicating with at least the module upstream therefrom and the module downstream therefrom in said chain, and the exit module being suitable for forwarding to the entry module the messages that have been received and processed successfully by the modules of said chain, with only one message at a time propagating along the itinerary.

2/ A method according to claim 1, wherein, after a given itinerary has been formed, the means and resources allocated to said itinerary in a state that has been verified as being correct are made unavailable for any other itinerary, wherein the entry signal remains allocated to a given itinerary throughout the entire duration of use and existence of said itinerary, and wherein the release sequence is applied initially to the entry signal.

3/ A method according to claim 1, wherein the stage of allocating modules to an itinerary is implemented by causing an allocation request message to propagate from module to module towards successive downstream modules starting from the entry module and going towards the exit module, the exit module returning said message to the entry module in the event of the corresponding itinerary being successfully opened, with the modules being allocated exclusively to the chain formed in this way.

4/ A method according to claim 1, wherein the verification stage consists in causing a verification request message to propagate to successive downstream modules, each module verifying the state of the associated means or resources as a function of the itinerary in question, in particular to detect state errors or breakdowns, in forwarding said message from the exit module to the entry module in the event of all of the inbetween modules and the exit module being verified successfully, and finally in verifying said entry module, thereby terminating said verification sequence.

5/ A method according to claim 1, wherein the release stage consists in propagating a release command successively from module to module along the chain of modules corresponding to the itinerary in question, the release command being forwarded from a module to the following module automatically or after verifying a corresponding state of the means or resources attached to the upstream module in question, with this being done as a function of the nature of the module in question and the means or resources attached thereto.

6/ A method according to claim 1, wherein the operating module is systematically and automatically informed of the interruption or the successful completion of a given operating sequence, an interruption of an allocation sequence or of a control/verification sequence leading automatically to the itinerary in question being released.

7/ A transmission or travel network comprising a plurality of means and resources suitable for cooperating to form routing itineraries, in particular track circuits and junction points, and an interlock system for forming and managing routes or itineraries in said network, wherein said system comprises firstly a plurality of software modules each controlling and inspecting a plurality of means and/or resources and having means for communicating with one or other modules, said modules being capable of being temporarily assembled together in ordered chains to form determined itineraries in accordance with instructions from an operator, and secondly an operating module forming an interface between the software modules of said system and the operator, and managing the itineraries formed in said network, in particular setting them up by allocating corresponding software modules and dismantling them by releasing said modules, the various stages in the existence of such an itinerary being defined by consecutive operating sequences affecting said software modules and their associated means and/or resources and comprising successive sequences for allocation, control/verification, and release, each itinerary being made up of an entry module suitable for generating an entry signal, one or more inbetween modules, and an exit module suitable for generating an exit signal, the instruction messages issued by the entry signal from the entry module being forwarded in the absence of conflict or fault, along the chain of modules corresponding to the itinerary being formed, each inbetween module of said chain being aware of and capable of communicating with at least the module upstream therefrom in said chain and with the module downstream therefrom in said chain, and the exit module being suitable for forwarding to the entry module those messages that have been received and processed successfully by the modules of said chain, only one message at a time propagating along the itinerary.

8/ A network suitable for implementing the method according to claim 1.

9/ A network according to claim 7, the network being constituted by a railway network.

10/ A network according to claim 7, consisting in a communications or telecommunications network, for example a network of the type implementing packet transmission.
